(19) United States
(12) Patent Application Publication
(10) Pub. No.: US 2023/0094189 A1
(43) Pub. Date: Mar. 30, 2023

(54) METHOD AND APPARATUS FOR REDUCING DYNAMIC FORCES ON DOORS AND WINDOWS AND BARRIERS AND THEIR SUPPORTS

(71) Applicant: Sam Austin, Beaverton, OR (US)

(72) Inventor: Sam Austin, Beaverton, OR (US)

(21) Appl. No.: 17/929,727

(22) Filed: Sep. 5, 2022

Related U.S. Application Data
(60) Provisional application No. 63/249,387, filed on Sep. 28, 2021.

(51) Int. Cl. E06B 5/00; E06B 7/28; E06B 3/70

(52) U.S. Cl. CPC E06B 5/003; E06B 7/28; E06B 3/70; E06B 2003/7059

(57) ABSTRACT

A method is provided for reducing dynamic forces on doors and windows and barriers and their supports. At least one impact receiver 10 is provided to receive the dynamic forces from its source. At least one impact reducer 20 is provided to transfer the dynamic forces from the impact receiver 10 to the supports while undergoing elastic deformation. Elastic deformation of the impact reducer 20 elongates the duration of the dynamic force, and reduces the dynamic forces on the doors and windows and barriers and their supports.

### BACKGROUND PRIOR-ART

(Classification Codes: F16F, E06B5/113)

The following is a tabulation of some prior-art that presently appears relevant:

| | Kind | | |
|---|---|---|---|
| | Code | Issue Date | Patentee |
| Patent Number | | | |
| U.S. Pat. No. 4,854,621 | — | 1989 Aug. 8 | Baldwin |
| U.S. Pat. No. 5,241,790 | — | 1993 Sep. 7 | Schimpf |
| U.S. Pat. No. 5,581,948 | — | 1996 Dec. 10 | Simonsen |
| U.S. Pat. No. 8,201,367 | B2 | 2012 Jun. 19 | Barnard et al. |
| U.S. Pat. No. 9,657,511 | B2 | 2017 May 23 | Pfau et al. |
| U.S. Pat. No. 9,666,044 | B1 | 2017 May 30 | Buller et al. |
| Patent Application Number | | | |
| US 2011/0314762 | A1 | 2011 Dec. 29 | Widmer et al. |
| US 2018/0162021 | A1 | 2018 Jun. 14 | Gupta et al. |

Dynamic forces including forces from impacts and blasts can cause damages in doors and windows and barriers and their supports. One method of enabling doors and windows and barriers and their supports to withstand dynamic forces, is to increase their strength.

Strength of doors and windows and barriers can be increased by increasing the size of their parts, modifying existing parts, or adding extra parts. Examples of this method are the proposed designs of U.S. Pat. Nos. 4,854,621, 5,241,790, 5,581,948, and 9,666,044 B1 in which extra parts are added to doors. Other examples are proposed designs of U.S. Pat. No. 9,657,511 B2, and US patent application numbers 2011/0314762 A1 and 2018/0162021 A1, in which foam is placed into the door cavity. Increasing the parts size and adding extra parts increase the cost of construction, transportation, and installation. They also increase the weight of the doors and windows, which results in a more difficult and dangerous operation depending on the type of the doors and windows for example the sliding and swinging types. When modification is in specific locations of the doors and windows and barriers and their supports, the rest of the doors and windows and barriers and their supports remain unprotected.

Strength of doors and windows and barriers can also be increased by using stronger materials. This increases the cost and does not reduce the dynamic forces on the supports.

These methods often increase the rigidity and weight of the doors and windows and barriers and increases the unintentional damages and injuries on objects and people impacted by the doors and windows and barriers.

Another method of enabling doors and windows and barriers and their supports to withstand dynamic forces is to reduce the dynamic forces using energy-dissipating mechanisms. One example is the proposed design of the U.S. Pat. No. 8,201,367 B2 in which the door has a honeycomb structure that dissipates the impact energy by sustaining permanent and inelastic deformation during the impact. This mechanism experiences a partial or complete loss of function after sustaining a permanent deformation. The deformed honeycomb structure needs to be repaired or replaced to restore its energy-dissipating function. This is costly and takes time.

Advantages

Accordingly several advantages of one or more aspects are as follows: to enable the doors and windows and barriers and their supports to withstand dynamic forces from heavier objects and more powerful blasts without the need for modifying existing parts or increasing parts size or stronger materials, and to maintain their capacity to reduce dynamic forces. Other advantages are to reduce the weight and the cost of construction, transportation, and installation of the doors and windows and barriers, and to reduce the damages and injuries from impacts and blasts on the doors and windows and barriers. Other advantages of one or more aspects will be apparent from a consideration of the drawings and ensuing description.

### Definitions of Some Terms

In the following text, part of the doors and windows and barriers receiving the dynamic forces from its source is called “impact receiver”. Part of the doors and windows and barriers and their supports that undergoes elastic deformation due to the dynamic forces is called “impact reducer”. Part of the doors and windows and barriers that transfers the dynamic forces to their supports is called “backing”. Part of the doors and windows and barriers that keeps the impact receiver, the impact reducer, and the backing contiguous is called “coupler”. Part of the doors and windows and barriers that guides the impact receiver towards the impact reducer is called “joint”.

### SUMMARY

In accordance with one embodiment an apparatus for reducing dynamic forces on doors and windows and barriers and their supports comprises at least one impact receiver 10 on sides of the doors and windows and barriers that receive the dynamic forces and at least one impact reducer 20 transferring the dynamic forces from the impact receiver 10 to the supports while undergoing elastic deformation. Elastic deformation of the impact reducer 20 elongates the duration of the dynamic forces and reduces the dynamic forces on the doors and windows and barriers and their supports. Another embodiment comprises of at least one impact receiver 10 and at least one impact reducer 20 and at least one coupling means 40 for keeping the impact receiver 10 and the impact reducer 20 contiguous without transferring the dynamic forces from the impact receiver 10 to the supports. Another embodiment comprises of at least one impact receiver 10 and at least one impact reducer 20 and at least one joint 50 guiding the impact receiver 10 towards the impact reducer 20. Another embodiment comprises of at least one impact receiver 10 and at least one impact reducer 20 and at least one coupling means 40 and at least one joint 50. Another embodiment comprises of at least one impact receiver 10 and at least one impact reducer 20 and at least one backing 30 receiving the dynamic forces from the impact reducer 20 and transferring it to the supports. Another embodiment comprises of at least one impact receiver 10 and at least one impact reducer 20 and at least one backing 30 and at least one coupling means 40. Another embodiment comprises of at least one impact receiver 10 and at least one impact reducer 20 and at least one backing 30 and at least one joint 50. Another embodiment comprises of at least one impact receiver 10 and at least one impact reducer 20 and at least one backing 30 and at least one coupling means 40 and at least one joint 50.

### DRAWINGS—FIGURES

In the drawings, related figures have the same number with different alphabetic suffixes.

FIG. 1A is a comprehensive isometric view of the first embodiment;

FIG. 1B is an isometric view of the first embodiment before the dynamic forces are applied;

FIG. 1C is a cross-sectional view taken along line 1-1 of FIG. 1B before the dynamic forces are applied;

FIG. 1D is an enlarged view of the encircled portion labeled 1 in FIG. 1C before the dynamic forces are applied;

FIG. 1E is an enlarged view of the encircled portion labeled 1 in FIG. 1C while the dynamic forces are applied;

FIG. 2A is an isometric exploded view of the second embodiment;

FIG. 2B is an isometric view of the second embodiment before the dynamic forces are applied;

FIG. 2C is a cross-sectional view taken along line 2-2 of FIG. 2B before the dynamic forces are applied;

FIG. 2D is an enlarged view of the encircled portion labeled 2 in FIG. 2C before the dynamic forces are applied; and

FIG. 2E is an enlarged view of the encircled portion labeled 2 in FIG. 2C while the dynamic forces are applied.

### DRAWINGS—REFERENCE NUMERALS

| | | | |
|---|---|---|---|
| 10 | impact receiver | 30 | backing |
| 12 | impact receiver plate | 32 | backing plate |
| 13 | impact receiver plate surface | 33 | backing plate surface |
| 14 | impact receiver peripheral stiffener | 34 | backing peripheral stiffener or frame |
| 15 | impact receiver peripheral surface | 35 | backing peripheral surface |
| 16 | impact receiver intermediate stiffener | 40 | coupler |
| 20 | impact reducer | 42 | coupler latch |
| 22 | impact reducer springs | 42a | coupler latch end piece |
| 24 | impact reducer foams | 42b | coupler latch base piece |
| | | 44 | coupler hole |
| | | 50 | joint |

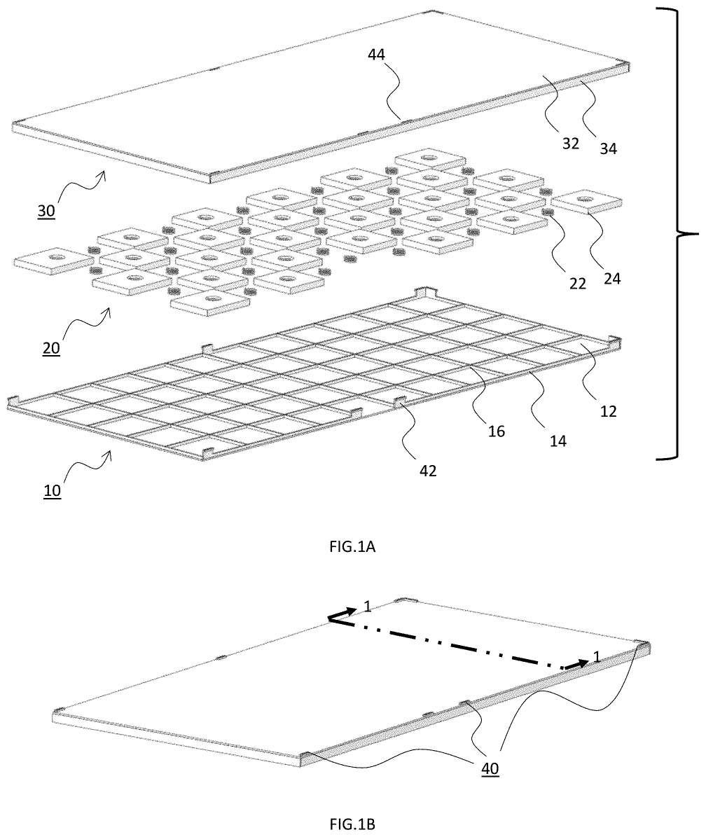

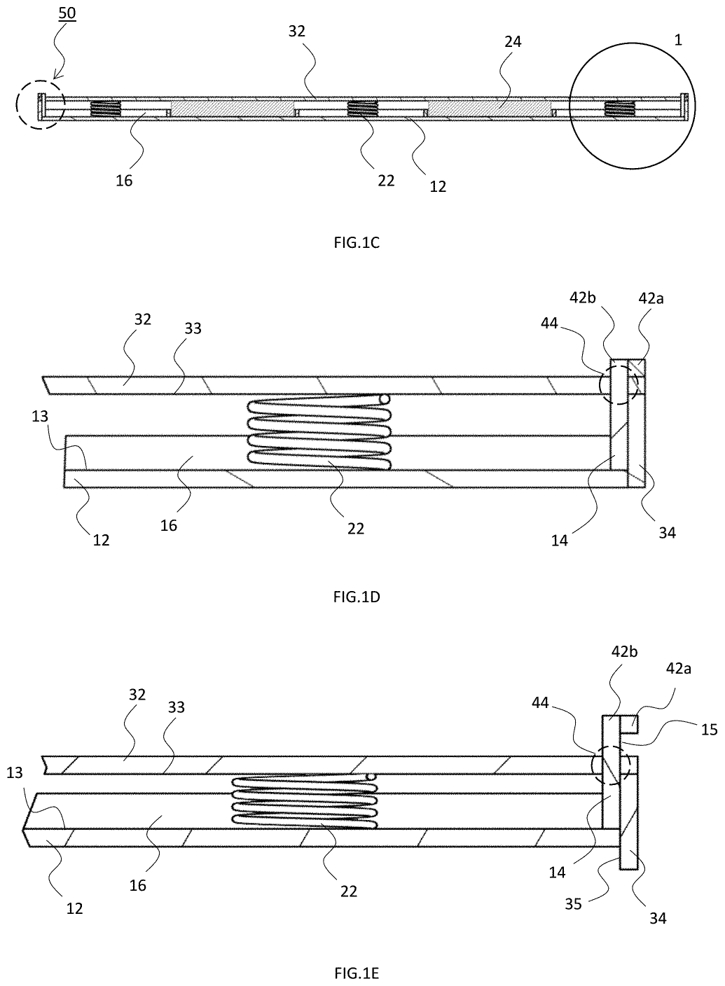

### DETAILED DESCRIPTION—FIRST EMBODIMENT—FIGS. 1A, 1B, 1C, AND 1D

The first embodiment is illustrated in FIG. 1A (exploded isometric view) and FIG. 1B (isometric view) and FIG. 1C (cross-sectional view) and FIG. 1D (enlarged cross-sectional view). It comprises an impact receiver 10, an impact reducer 20, a backing 30, a plurality of couplers 40, and a joint 50.

The impact receiver 10 comprises a plate 12 made from steel and peripheral stiffeners 14 and horizontal and vertical intermediate stiffeners 16 made from steel welded to surface 13 of the plate 12 at predetermined distances. The impact reducer 20 comprises elastically deformable steel springs 22 and foams 24 disposed against the surface 13 of the plate 12 at predetermined locations between the peripheral stiffeners 14 and intermediate stiffeners 16. The backing 30 comprises a plate 32 made from steel and peripheral stiffeners 34 made from steel welded to the surface 33 of the plate 32. The length between the peripheral stiffeners 34 of the backing 30 is slightly larger than the exterior length of the impact receiver 10. Couplers 40, as seen in FIGS. 1D and 1E, comprise L-shaped latches 42 attached to the surface 13 of the plate 12, and their corresponding holes 44 on the plate 32 of the backing 30.

The impact receiver 10 and the impact reducer 20 are inserted in the backing 30 to make the impact reducer 20 touch the surface 33 of the plate 32 and so that the coupler latches 42 projecting outward from the surface 13 are aligned with and extend outward from their corresponding holes 44. The end pieces 42a of the L-shaped latches 42 are welded to the base piece 42b after the insertion. The joint 50, as seen in FIG. 1C, comprises the surfaces 15 of the impact receiver 10 and the surfaces 35 of the backing 30. The surfaces 15 and/or 35 are coated with a low-friction material.

### Operation—First Embodiment—FIG. 1E

The operation of the first embodiment is illustrated in FIG. 1E (which illustrates an enlarged cross-sectional view while dynamic forces are applied). The impact receiver 10 receives the dynamic forces from its source and starts moving towards the plate 32 of the backing 30. Joint 50 guides the impact receiver 10 towards the impact reducer 20. The low-friction material coating on the surface 15 and surface 35 of the joint 50 reduces the friction and prevents sticking of the joint 50. Stiffeners 34 of the backing 30 reduce tilting of the impact receiver 10 inside the backing 30. This makes the elastic deformation of the impact reducer 20 more uniform when the dynamic forces are applied to other than the center of the impact receiver 10. Couplers 40 keep the impact receiver 10, the impact reducer 20, and the backing 30 contiguous before, during, and after the dynamic forces are applied. Elastic deformation of the impact reducer 20 elongates the duration of the dynamic forces and reduces the dynamic forces. Deformation of the impact receiver 10 and the backing 30 further elongates the duration of the dynamic force, and reduces the dynamic forces. Elastic deformation of the impact reducer 20 is larger than the deformation of the backing 30. The damping effect of the foam materials 24 diminish the vibration after the application of the dynamic forces and thereby reduces damage from resonating loads.

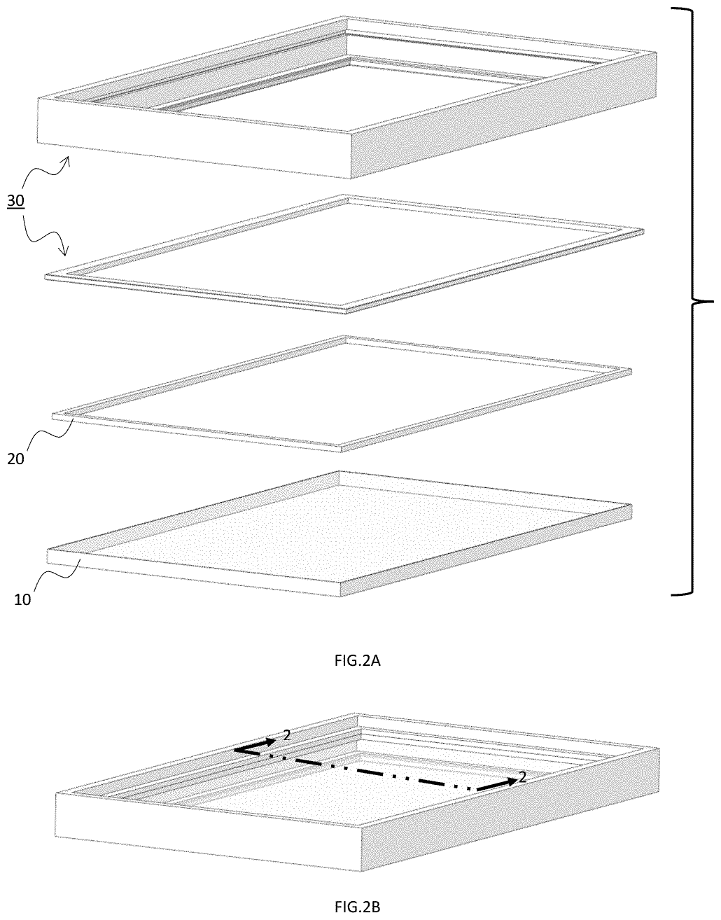

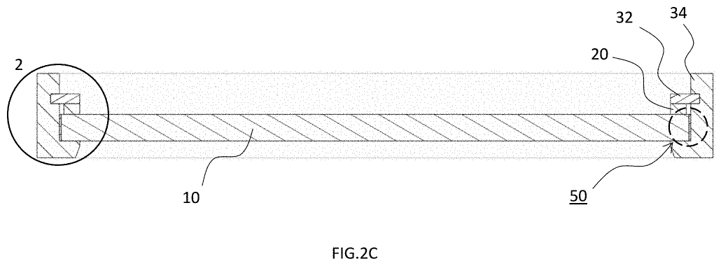

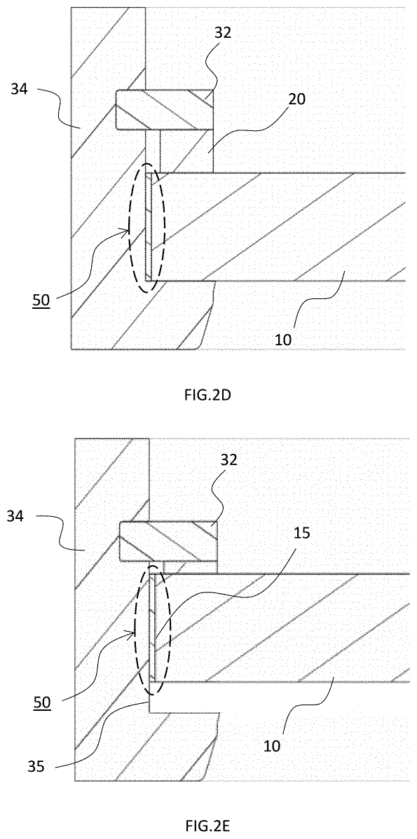

### Detailed Description—Second Embodiment—FIGS. 2A, 2B, 2C, AND 2D

The second embodiment is illustrated in FIG. 2A (exploded isometric view) and FIG. 2B (isometric view) and FIG. 2C (cross-sectional view) and FIG. 2D (enlarged cross-sectional view). It comprises an impact receiver 10, an impact reducer 20, a backing 30, and a joint 50. The impact receiver 10 is made of an impact and blast-resistant glass sheet and the impact reducer 20 is made of an elastically deformable frame-shaped foam. The backing 30 comprises four plates 32 made of aluminum and a peripheral frame 34 made of aluminum. First, the impact receiver 10 is placed in the peripheral frame 34. Next, the impact reducer 20 is glued to the impact receiver 10. Finally, the plates 32 are embedded in the frame 34. The joint 50 comprises the surfaces 15 of the impact receiver 10 and the surfaces 35 of the backing 30. The surfaces 15 and/or 35 are coated with a low-friction material.

### Operation—Second Embodiment—FIG. 1E

The operation of the second embodiment is illustrated in FIG. 2E (enlarged cross-sectional view during the application of the dynamic force). The impact receiver 10 receives the dynamic forces from its source and starts moving towards the backing 30. Joint 50 guides the impact receiver 10 towards the impact reducer 20. The low-friction material coating on the surfaces 15 of the joint 50 reduces the friction and prevents sticking of the joint 50. Peripheral frame 34 of the backing 30 reduces tilting of the impact receiver 10 inside the backing 30. This makes the elastic deformation of the impact reducer 20 more uniform when the dynamic forces are not applied on the center of the impact receiver 10. Elastic deformation of the impact reducer 20 elongates the duration of the dynamic force, and reduces the dynamic forces. Deformation of the backing 30 further elongates the duration of the dynamic force, and reduces the dynamic forces. Elastic deformation of the impact reducer 20 is larger than the deformation of the backing 30. Damping effect of the foam 24 diminishes the vibration after the application of the dynamic force, and reduces damages from resonating loads.

Advantages

From the description above, a number of advantages of some embodiments become evident:
a) The dynamic forces are reduced on all parts of the doors and windows and barriers and their supports including the hinges and locking mechanisms;
b) The doors and windows and barriers and their supports can withstand dynamic forces from heavier objects and more powerful blasts;
c) The doors and windows and barriers and their supports can withstand dynamic forces with no need for modifying existing parts;
d) The doors and windows and barriers and their supports can withstand dynamic forces with no need for increasing the size of existing parts;
e) The doors and windows and barriers and their supports can withstand dynamic forces with no need for stronger materials;
f) The doors and windows and barriers maintain their capacity to reduce dynamic forces after application of a dynamic force;
g) Safety and ease of operation is increased depending on the type of the doors and windows;
h) The cost of construction, transportation, and installation of the doors and windows and barriers and their supports is reduced;
i) The damages and injuries on humans and objects from impacting the doors and windows and barriers are reduced;
j) The damages from the dynamic forces in the doors and windows and barriers and their supports are reduced; and
k) Weight of the doors and windows and barriers and their supports is reduced.

### Alternate Embodiments

Applications

One application of the method and apparatus for reducing dynamic forces is in construction of doors. Another application is in construction of windows. Another application is in construction of barriers. Another application is in construction of security doors. Another application is in construction of security windows. Another application is in construction of security barriers. Another application is in construction of blast-resistant doors. Another application is in construction of blast-resistant windows. Another application is in construction of blast-resistant barriers.

Association/Connection

There are various possibilities with regard to connecting the impact reducer 20 to the impact receiver 10 and backing 30. In one configuration, the impact reducer 20 is attached to the impact receiver 10. In another configuration, the impact reducer 20 is attached to the backing 30. In another configuration, the impact reducer 20 is attached to both the impact receiver 10 and the backing 30. In another configuration, the impact reducer 20 is detached from both the impact receiver 10 and the backing 30.

Construction

There are also various methods to attach the parts of the impact receiver 10, impact reducer 20, backing 30, coupler 40, and joint 50. These include fastening, inserting, using adhesives, welding, and other attachment methods.

Duplication/Elimination

There are also various possibilities with regard to the number of impact receivers 10. In one configuration, the doors and windows and barriers have one impact receiver 10. In another configuration, the doors and windows and barriers have a plurality of impact receivers 10. There are also various possibilities with regard to the number of impact reducers 20. In one configuration, the doors and windows and barriers have one impact reducer 20. In another configuration, the doors and windows and barriers have a plurality of impact reducers 20. There are also various possibilities with regard to the number of backings 30. In one configuration, the doors and windows and barriers have one backing 30. In another configuration, the doors and windows and barriers have a plurality of backings 30. There are also various possibilities with regard to the number of couplers 40. In one configuration, the doors and windows and barriers have one coupler 40. In another configuration, the doors and windows and barriers have a plurality of couplers 40. There are also various possibilities with regard to the number of joints 50. In one configuration, the doors and windows and barriers have one joint 50. In another configuration, the doors and windows and barriers have a plurality of joints 50. There are also various possibilities with regard to the number of supports. In one configuration, the doors and windows and barriers have one support. In another configuration, the doors and windows and barriers have a plurality of supports.

Materials

There are also various possibilities with regard to the material used for construction of the impact receiver 10, impact reducer 20, backing 30, coupler 40, and joint 50, including carbon fiber, glass, metal, polymers, wood, and other engineering materials. The impact reducer 20 is made of materials and devices that can elastically deform including foam and spring. The impact reducer 20 deforms under the dynamic load and when the load is removed goes back to its original shape. The joint 50 can have a coating of materials with low-friction properties. Joint 50 can include ball bearings and other low-friction mechanisms.

### MODES OF OPERATION

There are also various possibilities with regard to the mode of operation. In one configuration, the impact reducer 20 works in compression. In another configuration, the impact reducer 20 works in tension.

Parts

There are also various possibilities with regard to the parts used in the doors and windows and barriers. In one configuration, the doors and windows and barriers comprise at least one impact receiver 10 and at least one impact reducer 20. In another configuration, the doors and windows and barriers comprise at least one impact receiver 10 and at least one impact reducer 20 and couplers 40. In another configuration, the doors and windows and barriers comprise at least one impact receiver 10 and at least one impact reducer 20 and at least one joint 50. In another configuration, the doors and windows and barriers comprise at least one impact receiver 10 and at least one impact reducer 20 and couplers 40 and at least one joint 50. In another configuration, the doors and windows and barriers comprise at least one impact receiver 10 and at least one impact reducer 20 and at least one backing 30. In another configuration, the doors and windows and barriers comprise at least one impact receiver 10 and at least one impact reducer 20 and at least one backing 30 and couplers 40. In another configuration, the doors and windows and barriers comprise at least one impact receiver 10 and at least one impact reducer 20 and at least one backing 30 and at least one joint 50. In another configuration, the doors and windows and barriers comprise at least one impact receiver 10 and at least one impact reducer 20 and at least one backing 30 and couplers 40 and at least one joint 50. There are also various possibilities with regard to how the doors and windows and barriers are connected to their supports. It includes types of frames, hinges, locks, rails, and bearings.

Parts Order

There are also various possibilities with regard to the order of the impact receiver 10, the impact reducer 20, and the backing 30. In one configuration, the impact reducer 20 is sandwiched between the impact receiver 10 and the backing 30. In another configuration the backing 30 is sandwiched between the impact receiver 10 and the impact reducer 20. In another configuration the backing 30 is sandwiched between one impact reducer 20 and one impact receiver 10 on one side and another impact reducer 20 and impact receiver 10 on the other side. There are also various possibilities with regard to position of the couplers 40. In one configuration, the coupler latches 42 are attached to the impact receiver 10 and the corresponding holes 44 are located on the backing 30. In another configuration, the coupler latches 42 are attached to the backing 30 and the corresponding holes 44 are located on the impact receiver 10.

Shapes and Sizes

There are various possibilities with regard to shapes, sizes, and placement patterns of the comprising parts of the impact receiver 10, the impact reducer 20, the backing 30, the coupler 40, the joint 50, and their parts.

### CONCLUSION

Described method and apparatus, reduces dynamic forces on all parts of the doors and windows and barriers and their supports, thus the reader will see that this method has the additional advantages in that:
It enables the doors and windows and barriers and their supports to withstand dynamic forces from heavier objects and more powerful blasts
It enable the doors and windows and barriers and their supports to withstand dynamic forces without the need for modifying existing parts
It enables the doors and windows and barriers and their supports to withstand dynamic forces without the need for increasing parts size
It enables the doors and windows and barriers and their supports to withstand dynamic forces without the need for stronger materials
It enables the doors and windows and barriers to maintain their capacity to reduce dynamic forces after the application of the dynamic force
It increases the safety and ease of operation depending on the type of the doors and windows
It reduces the cost of construction, transportation, and installation of the doors and windows and barriers and their supports
It reduces the damages and injuries from the doors and windows and barriers impacting humans, animals, and objects
It reduces the damages from dynamic forces on the doors and windows and barriers and their supports
It reduces the weight of the doors and windows and barriers and their supports

Ramifications and Scope

While the above descriptions contain many specificities, they are merely exemplification of several embodiments and what is presently contemplated for them and should not be construed as limitations on the scope. Accordingly, the scope should be determined not by the illustrated embodiment(s) but by the appended claims and their legal equivalents.

I claim:

1. An apparatus for reducing dynamic forces on doors and windows and barriers and their supports, comprising:
a) at least one impact receiver 10 on sides of the doors and windows and barriers that receive the dynamic forces; and
b) at least one impact reducer 20 transferring the dynamic forces from the impact receiver 10 to the supports while undergoing elastic deformation,
whereby the at least one impact reducer 20 elongates the duration of the dynamic forces and reduces the dynamic forces.

2. The apparatus of claim 1, further comprising: at least one coupling means 40 for keeping the at least one impact receiver 10 and the at least one impact reducer 20 contiguous without transferring the dynamic forces from the at least one impact receiver 10 to the supports.

3. The apparatus of claim 1, further comprising: at least one joint 50 guiding the at least one impact receiver 10 towards the at least one impact reducer 20.

4. The apparatus of claim 1, further comprising: at least one coupling means 40 keeping the at least one impact receiver 10 and the at least one impact reducer 20 contiguous without transferring the dynamic forces from the at least one impact receiver 10 to the supports and at least one joint 50 guiding the at least one impact receiver 10 towards the at least one impact reducer 20.

5. The apparatus of claim 1, further comprising: at least one backing 30 receiving the dynamic forces from the at least one impact reducer 20 and transferring it to the supports.

6. The apparatus of claim 5, further comprising: at least one coupling means 40 for keeping the at least one impact receiver 10 and the at least one impact reducer 20 and the at least one backing 30 contiguous without transferring the dynamic forces from the at least one impact receiver 10 to the at least one backing 30.

7. The apparatus of claim 5, further comprising: at least one joint 50 guiding the at least one impact receiver 10 towards the at least one impact reducer 20.

8. The apparatus of claim 5, further comprising: at least one coupling means 40 for keeping the at least one impact receiver 10 and the at least one impact reducer 20 and the at least one backing 30 contiguous without transferring the dynamic forces from the at least one impact receiver 10 to the at least one backing 30 and at least one joint 50 guiding the at least one impact receiver 10 towards the at least one impact reducer 20.

9. A method for reducing dynamic forces on doors and windows and barriers and their supports, comprising:
c) receiving the dynamic forces on sides of the doors and windows and barriers using at least one impact receiver 10; and
d) transferring the dynamic forces from the impact receiver 10 to the supports using at least one elastically deformable impact reducer 20,
whereby the at least one impact reducer 20 elongates the duration of the dynamic forces and reduces the dynamic forces.

10. The method of claim 9, further comprising: keeping the at least one impact receiver 10 and the at least one impact reducer 20 contiguous without transferring the dynamic forces from the at least one impact receiver 10 to the supports using at least one coupling means 40.

11. The method of claim 9, further comprising: guiding the at least one impact receiver 10 towards the at least one impact reducer 20 using at least one joint 50.

12. The method of claim 9, further comprising: keeping the at least one impact receiver 10 and the at least one impact reducer 20 contiguous without transferring the dynamic forces from the at least one impact receiver 10 to the supports using at least one coupling means 40 and guiding the at least one impact receiver 10 towards the at least one impact reducer 20 using at least one joint 50.

13. The method of claim 9, further comprising: receiving the dynamic forces from the at least one impact reducer 20 and transferring it to the supports using at least one backing 30.

14. The method of claim 13, further comprising: keeping the at least one impact receiver 10 and the at least one impact reducer 20 and the at least one backing 30 contiguous without transferring the dynamic forces from the at least one impact receiver 10 to the at least one backing 30 using at least one coupling means 40.

15. The method of claim 13, further comprising: guiding the at least one impact receiver 10 towards the at least one impact reducer 20 using at least one joint 50.

16. The method of claim 13, further comprising: keeping the at least one impact receiver 10 and the at least one impact reducer 20 and the at least one backing 30 contiguous without transferring the dynamic forces from the at least one impact receiver 10 to the at least one backing 30 using at least one coupling means 40 and guiding the at least one impact receiver 10 towards the at least one impact reducer 20 using at least one joint 50.
